(19) United States
(12) Patent Application Publication
(10) Pub. No.: US 2026/0192424 A1
(43) Pub. Date: Jul. 9, 2026

(54) HAND TOOL FOR CONNECTING OR DISCONNECTING HOSES

(71) Applicant: Xiao Gang JING, Edmonton (CA)

(72) Inventor: Xiao Gang JING, Edmonton (CA)

(21) Appl. No.: 19/055,539

(22) Filed: Feb. 18, 2025

(30) Foreign Application Priority Data
Jan. 3, 2025 (CA) 3261232

(51) Int. Cl. B25B 27/10

(52) U.S. Cl. CPC B25B 27/10

(57) ABSTRACT

The invention provides a hand tool for connecting or disconnecting hoses by simultaneously griping, pulling and twisting hose fittings with amplified forces. It comprises two grippers each having two legs pin-jointed at one end for gripping, a twist guide arm structured as a U-shaped bracket with a curved guide slot on each ear attaching one gripper by clasping gripper joint pin within two slots to make this gripper rotatable around fittings'axial line by sliding joint pin along slots for twisting, and a span adjustable link rod connecting the twist guide arm and the other gripper by another two joints on their other ends. When engaging fittings with grippers, sections on both sides of the link rod form a lever-couple pivoted at joints the link rod attached for pulling. While gripping and pulling fittings, twist the twistable fitting by the rotatable gripper to finish connecting or disconnecting.

### BACKGROUND OF THE INVENTION

This invention relates to a hand tool, more particularly a hand tool for connecting or disconnecting hoses. When connecting or disconnecting hoses with some types of fitting manually, such as Chicago fitting, dual-lock fitting, people need to grip, pull, and twist hose fittings simultaneously. But performing these three actions concurrently with only bare hands is exceedingly difficult for some people who are not capable enough on muscle and/or for some working conditions such as greasy hoses or gloves, wet or freezing environment, and awkward position or location. It calls for a hand tool to make it easy. Patent US 20130283582 (CA 2823552) introduces a hand tool just for attaching a non-fitting flex hose to a nipple by looping and pulling. U.S. Pat. No. 8,978,226 (CA 2878443) describes a hand tool like an electrical wire stripper on shape just for disconnecting tubes with quick connectors by gripping and pushing. Even though in the latest patent database there are prior arts like these aiming at hand tools for connecting or disconnecting hoses or tubes on some specific applications, none of them can accomplish gripping, pulling, and twisting all three actions at the same time by their designs, so that none of them are applicable to the subject and problem this invention intends to deal with. Based on this, the invention is created.

### SUMMARY OF THE INVENTION

This invention provides a hand tool for connecting or disconnecting hoses with some types of fitting, such as Chicago fitting, dual-lock fitting, by simultaneously gripping, pulling, and twisting hose fittings with amplified forces. It comprises two grippers, a twist guide arm, and a link rod. Each gripper has two legs of gripping jaws jointed by a rotating pin on one end.

The twist guide arm is a U-shaped bracket with a curved guide slot on each ear and attaches one gripper in the manner that it clasps the joint pin of the gripper within the two slots so that the joint pin can slide along the slots freely and this gripper is rotatable to a certain angle around the axial line of hose fittings clockwise or counterclockwise from the centers of the slots when the tool is in operation. A structure of a rotating pin joint on another bracket is on the other end of the twist guide arm. A same and parallel structure pairs it on the extension of one leg of the other gripper from the joint point of the two legs. The link rod connects the twist guide arm and rotatable gripper assembly with the other gripper to combine them into one functional tool through the joint pins of these two structures at its respective end in the manner that the link rod is perpendicular to the planes of the two grippers and each section beside the link rod is swingable around the pin. The span of the link rod is adjustable for positioning the two grippers to various desired spacing.

The grippers with long enough legs give easy gripping on hose fittings by virtue of the second-class lever function. When engaging the two fittings with the two grippers, and the twist guide arm aligning with the rotatable gripper, sections on both sides of link rod also form a second-class lever-couple pivoted at joints where the link rod attaches to give easy pulling on hose fittings. While gripping and pulling, twisting the twistable fitting to lock or unlock fittings can be achieved by the rotatable gripper easily with the help of another effort-saving lever action.

To use this tool to connect or disconnect hoses, firstly adjust the link rod for desired span, then grip and engage both hose fittings by grippers with the twist guide arm aligning with the rotatable gripper, then pull hose fittings towards each other by both sections hinged on the link rod, then twist the twistable fitting with the rotatable gripper clockwise or counterclockwise quickly to lock or unlock the fittings to finish connecting or disconnecting hoses.

### BRIEF DESCRIPTION OF THE DRAWINGS

FIG. 1 is the perspective view of the tool to illustrate its structure.

FIG. 2 is the perspective view of the twist guide arm component only to illustrate the twist guide slots on both ears of the U-shaped bracket specially.

### DETAILED DESCRIPTION OF THE INVENTION

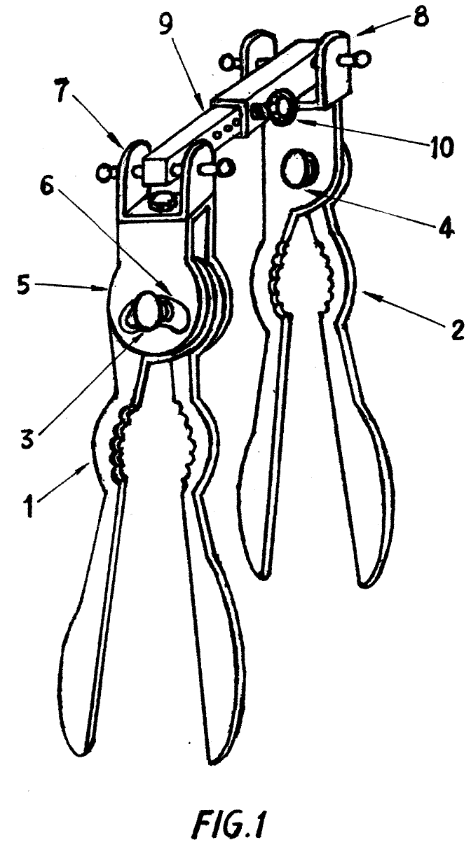

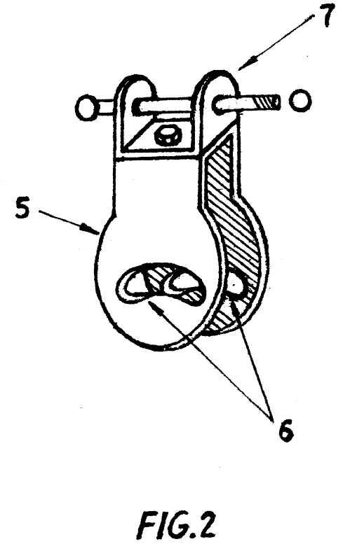

A preferred embodiment of the invention is shown in FIG. 1. Grippers 1 and 2 with rotating pin joints 3 and 4 and gripping jaws on each pair of legs respectively are for gripping hose fittings. With long enough legs, they can grip hose fittings easily due to the second-class lever function. Twist guide arm 5 is a relatively short U-shaped bracket with a curved guide slot 6 on each ear, and a structure 7 of a rotating pin joint on another bracket on the other end of the twist guide arm, as illustrated individually in FIG. 2. The curve of the slots is a segment of the circle centered on the axial line of the hose fittings when the fittings are gripped by grippers. The twist guide arm 5 attaches gripper 1 through the two guide slots 6 in the manner that the arm clasps the pin of joint 3 within the guide slots 6 so that the pin of joint 3 can slide along the slots 6 freely and the gripper 1 is rotatable around the axial line of hose fittings to an angle clockwise or counterclockwise from the centers of the slots 6 when the tool is in operation. One leg of gripper 2 extends from joint 4 of the two legs to a structure 8 which is the same and parallel to structure 7 so that gripper 2 is not rotatable in contrast to gripper 1. A link rod 9 connects the joint pins on structure 7 and 8 at the respective end to combine the two sections beside it into one functional tool in the manner that the link rod 9 is perpendicular to the planes of gripper 1 and 2, and each section beside the link rod 9 is swingable around the pin. The attaching points of the link rod 9 on structure 7 and 8 are also the pivots of a second-class lever-couple formed by the twist guide arm and rotatable gripper assembly and the other gripper for easy pulling hose fittings. The span of the link rod 9 is adjustable controlled by set screw 10 for positioning gripper 1 and 2 to various desired spacing.

To use this tool to connect or disconnect hoses, firstly adjust the link rod 9 by set screw 10 for desired span, then grip and engage both hose fittings by grippers 1 and 2 with the twist guide arm 5 aligning with the rotatable gripper 1, then pull hose fittings towards each other by both sections hinged on the link rod 9, then twist the twistable fitting with the rotatable gripper 1 clockwise or counterclockwise quickly to lock or unlock the hose fittings to finish connecting or disconnecting hoses.

1. A hand tool, comprising two grippers, a twist guide arm attaching one of said two grippers, and a link rod connecting said twist guide arm and the other one of said two grippers.

2. A hand tool as in claim 1, wherein each of said two grippers has two legs jointed by a rotating pin joint at one end.

3. A hand tool as in claim 1, wherein said one of said two grippers attached by said twist guide arm is rotatable to certain angle clockwise or counterclockwise around the axial line of hose fittings gripped by said two grippers.

4. A hand tool as in claim 3, wherein said twist guide arm has curved guide slots attaching said one of said two grippers through said slots.

5. A hand tool as in claim 1, wherein said link rod is adjustable on its span.

6. A hand tool as in claim 1, wherein said link rod connects said twist guide arm and said the other one of said two grippers through rotating pin joints.
